(19) United States
(12) Patent Application Publication
(10) Pub. No.: US 2026/0130745 A1
(43) Pub. Date: May 14, 2026

(54) METHOD AND DEVICE FOR DISPLAYING ORAL MODELING IMAGE USED FOR MANUFACTURING INSERT BODY, AND RECORDING MEDIUM

(71) Applicant: OSSTEM IMPLANT CO., LTD., Seoul (KR)

(72) Inventors: Young Seok KIM, Anyang-si (KR); In Ho CHO, Seoul (KR); Kyoo Ok CHOI, Seoul (KR)

(21) Appl. No.: 18/860,210

(22) PCT Filed: Apr. 20, 2023
(86) PCT No.: PCT/KR2023/005352

§ 371 Date: Jul. 14, 2025

(30) Foreign Application Priority Data
Jun. 8, 2022 (KR) 10-2022-0069704

(51) Int. Cl. A61C 13/00; G06T 19/20

(52) U.S. Cl. CPC A61C 13/0004; G06T 19/20; G06T 2210/41; G06T 2219/2012

(57) ABSTRACT

Disclosed are a method, a device, and a recording medium, according to one embodiment, the method comprising the steps of: acquiring scan data for an oral cavity; acquiring undercut data including data on undercut location and undercut depth determined on the basis of an insertion path of an insert body corresponding to the oral cavity; acquiring an oral modeling image including an undercut area divided into a plurality of areas on the basis of the scan data and the undercut data; acquiring an updated oral modeling image on the basis of the undercut depth for an area adjacent to a target area according to a user input applied to the target area including one of the plurality of areas; and displaying the updated oral modeling image.

### TECHNICAL FIELD

The present disclosure relates to the technical field of displaying oral modeling images of undercuts used in the fabrication of a denture for an edentulous oral cavity.

### BACKGROUND ART

In the related art, an undercut refers to a specific area adjacent to the curve formed between the labial, buccal, or lingual skin and the gum within an oral cavity, which is used to improve the fit of an insert body (e.g., a denture) inserted into the oral cavity of an edentulous patient. The presence, depth, or area of the undercut may vary from one patient to another.

Depending on the presence, depth, or area of the undercut, the degree to which the insert body adheres to the oral cavity or the ease with which the insert body is smoothly inserted into the oral cavity may differ, and accordingly, the degree of pain experienced by the patient may vary. Additionally, by identifying a patient's undercut in advance, it becomes easier for the user to determine whether surgery on the patient's oral cavity is necessary before the fabrication of the insert body.

As such, it can be seen that it is important to utilize information about the patient's undercut to improve the fit, retention, ease of insertion, and pain associated with the insertion of the insert body, and to determine whether surgery is needed before fabricating the insert body. However, conventional technologies have the problem of providing only limited functionality, such as merely displaying the depth, area, etc., of the patient's undercut.

### DISCLOSURE

### Technical Problem

An embodiment of the present disclosure, which aims to solve the aforementioned problems of the related art, may provide a method and a device for updating a depth or the like of an undercut area that appears on an oral modeling image, as well as a computer program stored in a recording medium. The present disclosure addresses a technical problem of enabling the fabrication of an insert body with improved fit, retention, ease of insertion, and reduced pain by displaying an updated oral modeling image that includes an undercut area with updated depth or similar characteristics, while also allowing a user to easily determine whether surgery on the patient's oral cavity is necessary before fabricating the insert body.

The technical problems to be solved are not limited to those mentioned above, and various other technical problems may be included within the scope apparent to a person of ordinary skill in the art.

### Technical Solution

A method for displaying an oral modeling image used for manufacturing an insert body according to a first aspect of the present disclosure may include the steps of: acquiring scan data for an oral cavity; acquiring undercut data including data on undercut location and undercut depth determined on the basis of an insertion path of an insert body corresponding to the oral cavity; acquiring an oral modeling image including an undercut area divided into a plurality of areas on the basis of the scan data and the undercut data; acquiring an updated oral modeling image on the basis of the undercut depth for an area adjacent to a target area according to a user input applied to the target area including one of the plurality of areas; and displaying the updated oral modeling image.

Additionally, the plurality of areas may be distinguished based on the undercut depth and each area may correspond to a different color.

Additionally, the acquiring of the updated oral modeling image may include updating the undercut depth of the target area according to the undercut depth of the adjacent area.

Additionally, the undercut area may be determined on the basis of an insertion path that minimizes a depth of the undercut area among a plurality of insertion paths.

In addition, the plurality of areas may include a maxillary tuberosity buccal undercut area based on a buccal area along a connecting line that connects maxillary tuberosity landmarks.

Additionally, a color of a numerical value displayed to indicate a depth value of the maxillary tuberosity buccal undercut area included in the undercut area may be determined on the basis of the sum of undercut depth values of two areas that constitute the maxillary tuberosity buccal undercut area.

Additionally, the acquiring of the updated oral modeling image may include the steps of: determining the target area for undercut updating on the basis of a user input applied to the undercut area; and updating an undercut depth of the target area to correspond to the undercut depth of the adjacent area.

Additionally, the acquiring of the undercut data may include determining the undercut data such that the undercut depth is minimized on the basis of a plurality of insertion paths.

Additionally, the plurality of areas may include a plurality of pixels included in the undercut area, and the color corresponding to the plurality of areas may be determined according to the undercut depth of the plurality of areas.

In addition, the plurality of areas may be distinguished based on a range of undercut depth for the undercut area, and the color corresponding to the plurality of areas may be determined according to the range of undercut depth.

A device for displaying an oral modeling image used for manufacturing an insert body according to a second aspect of the present disclosure may include: a receiving unit configured to acquire scan data for an oral cavity and acquire undercut data including data on undercut location and undercut depth determined on the basis of an insertion path of an insert body corresponding to the oral cavity; a processor configured to acquire an oral modeling image including an undercut area divided into a plurality of areas on the basis of the scan data and the undercut data and acquire an updated oral modeling image on the basis of the undercut depth for an area adjacent to a target area according to a user input applied to the target area including one of the plurality of areas; and a display configured to display the updated oral modeling image.

Additionally, the plurality of areas may be distinguished based on the undercut depth and each area may correspond to a different color.

In addition, the plurality of areas may include a maxillary tuberosity buccal undercut area based on a buccal area along a connecting line that connects maxillary tuberosity landmarks.

In addition, the processor may determine the target area for undercut updating on the basis of a user input applied to the undercut area and may update the undercut depth of the target area to correspond to the undercut depth of the adjacent area.

According to a third aspect of the present disclosure, a computer-readable recording medium having stored thereon a program which, when executed by a computer system, causes the computer system to perform the method of the first aspect may be provided.

In addition, other specific details are included in the detailed description and drawings.

### Advantageous Effects

According to one embodiment, a user can easily identify an undercut area with different depth compared to the adjacent undercut areas.

Additionally, the depth of the undercut area can be updated through simple user input.

Moreover, the insertion path of an insert body with the minimal undercut can be easily determined.

Also, by displaying the undercut area as the insertion path is updated, the user can easily determine the optimal insertion path.

Furthermore, the fit and pain associated with the insertion of the insert body fabricated according to the present disclosure can be improved compared to those made using conventional techniques.

In addition, the user can easily determine whether surgery on the patient's oral cavity is necessary before fabricating the insert body.

Effects of the present disclosure are not limited to those mentioned above, and it should be understood that the effects of the present disclosure include all effects that can be inferred from the detailed description or the claims.

### DESCRIPTION OF DRAWINGS

FIG. 1 is a schematic diagram illustrating an example configuration of a device according to one embodiment.

FIG. 2 is a flowchart illustrating an example of a method for displaying an updated oral modeling image according to one embodiment.

FIG. 3 is a diagram illustrating an example of displaying a maxillary labial undercut area determined based on an insertion path of a maxillary insert body according to one embodiment.

FIG. 4 is a diagram illustrating an example in which maxillary tuberosity buccal undercut areas, mandibular tuberosity buccal undercut areas, and mandibular tuberosity lingual undercut areas are determined and displayed according to one embodiment.

FIG. 5 is a diagram illustrating an example of updating the undercut depth of a target area based on user input applied to the target area according to one embodiment.

FIG. 6 is a diagram illustrating an example of displaying a mandibular labial undercut area determined based on an insertion path of a mandibular insert body according to one embodiment.

### MODE OF THE INVENTION

The terms used in the present invention are selected from among common terms that are currently widely used in consideration of their functions in the present invention. However, the terms may be different according to an intention of one of ordinary skill in the art, a precedent, or the advent of new technology. Also, in particular cases, the terms are discretionally selected by the applicant of the present invention, and the meaning of those terms will be described in detail in the corresponding part of the detailed description. Therefore, the terms used in the present invention are not merely designations of the terms, but the terms are defined based on the meaning of the terms and content throughout the present invention.

Throughout the specification, it will be understood that when a component “includes (or comprises)” an element, unless there is another opposite description thereto, it should be understood that the component does not exclude another element but may further include another element. Furthermore, the term “unit (or part)” used in the specification refers to a unit for processing at least one function or operation, and the unit may be implemented by hardware or software, or by a combination of both hardware and software.

The present invention will now be described more fully with reference to the accompanying drawings for one of ordinary skill in the art to be able to perform the present invention without any difficulty. The invention may, however, be embodied in many different forms and should not be construed as being limited to the embodiments set forth herein.

Hereinafter, a plurality of embodiments will be described in detail with reference to the drawings.

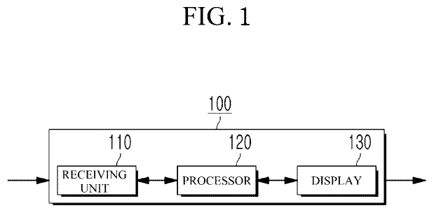

FIG. 1 is a schematic diagram illustrating an example configuration of a device 100 according to one embodiment.

Referring to FIG. 1, a device 100 may include a receiving unit 110, a processor 120, and a display 130.

The receiving unit 110 according to one embodiment may acquire undercut data, which includes data on undercut location and undercut depth determined on the basis of scan data for an oral cavity and an insertion path of an insert body corresponding to the oral cavity. The undercut location and undercut depth may be obtained based on the scan data of the maxilla and mandible and may include the undercut location and undercut depth for both the maxilla and mandible.

For example, the scan data for the oral cavity may include a three-dimensional (3D) scan image of the edentulous maxilla and mandible.

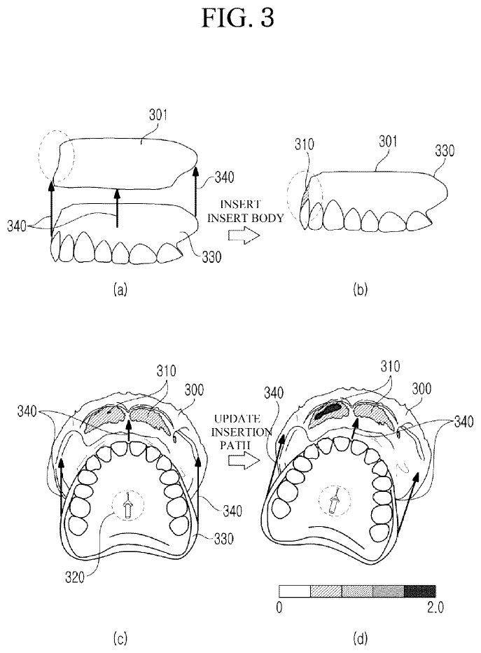

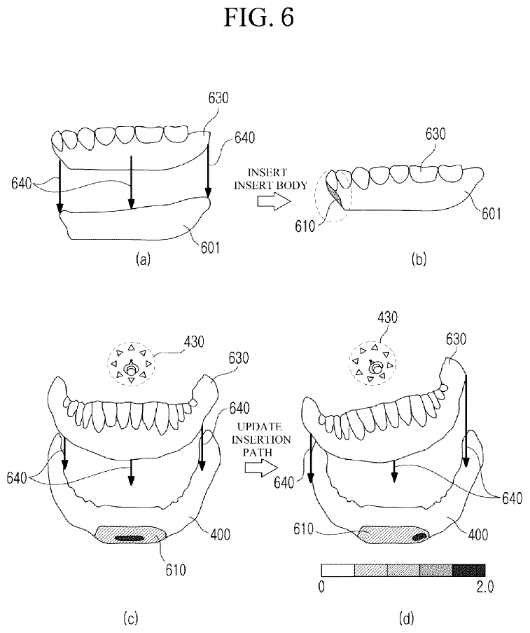

Referring to FIGS. 3 and 6, the insert bodies 330 and 630 corresponding to the oral cavity may include dentures or the like that can be inserted into the edentulous maxilla and mandible, and insertion paths 340 and 640 may be determined based on operation input (e.g., directional operation inputs or the like) applied to a maxillary insertion path UI 320 and a mandibular insertion path UI 430 shown in FIGS. 3, 4, and 6, and may be displayed on oral modeling images 300, 301, 400, and 601 to indicate the three-dimensional direction in which the insert bodies 330 and 630 can be substantially inserted into the maxilla and mandible. The insertion path 340 shown in (c) of FIG. 3 and the insertion path 640 shown in (c) of FIG. 6 represent the paths along which the insert bodies 330 and 630 are inserted in the direction of the occlusal plane (vertical) of a maxillary base modeling image 300 and a mandibular base modeling image 400, respectively. The oral modeling images 300, 301, 400, and 601 may include the maxillary base modeling image 300, a maxillary lateral modeling image 301, the mandibular base modeling image 400, and a mandibular lateral modeling image 601.

Also, in one embodiment, undercut areas 310, 421, 422, 441, 442, 443, 444, and 610, as shown in FIGS. 3 through 6, may include the deepest areas and adjacent areas of the labial curves of the maxilla and mandible, the buccal curves of the maxillary tuberosity, and the buccal and lingual curves of the mandibular tuberosity. Essentially, the undercut areas 310, 421, 422, 441, 442, 443, 444, and 610 may be acquired from the entire maxilla and mandible. The undercut areas 310, 421, 422, 441, 442, 443, 444, and 610 may include information not only on the location of the undercut, but also on the depth of the undercut.

Additionally, the receiving unit 110 may receive information provided from an external device (not shown). For example, the receiving unit 110 may include a wired or wireless communication device that can receive various types of information by being connected to an external device or external component (not shown) through a network or signal processing module.

The processor 120 according to one embodiment may determine a target area 510 for undercut updating on the basis of user input applied to the undercut areas 310, 421, 422, 441, 442, 443, 444, and 610 and may update the undercut depth of the target area 510 to correspond to the undercut depth of the adjacent area.

Also, the processor 120 may perform a series of operations to acquire the updated oral modeling image 500 and may be electrically connected to components not shown, in addition to the receiving unit 110 and the display, to control the data flow between them. For this purpose, the processor 120 may be implemented as a central processing unit (CPU) that controls the overall operation of the device 100.

The display 130 according to one embodiment may display the scan data, the undercut areas 310, 421, 422, 441, 442, 443, 444, and 610, the oral modeling images 300, 301, 400, and 601, and the updated oral modeling image 500.

In addition, it should be understood by those skilled in the art that, in addition to the components shown in FIG. 1, other general components may be further included in the device 100. According to one embodiment, the device 100 may further include a user interface unit for receiving user input and a storage unit configured to store data described throughout the specification.

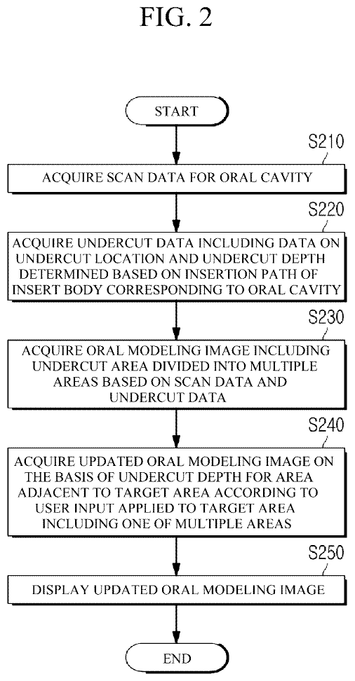

The embodiments described above will be explained in more detail with reference to FIGS. 2 to 5.

FIG. 2 is a flowchart illustrating an example of a method for displaying an updated oral modeling image according to one embodiment.

In step S210, a device 100 may acquire scan data for an oral cavity. For example, the scan data for the oral cavity may include a 3D scan image of the edentulous maxilla and mandible.

In step S220, the device 100 may acquire undercut data, which includes data on undercut location and undercut depth determined on the basis of an insertion path of an insert body corresponding to the oral cavity.

In one embodiment, the undercut data may include information on the undercut location and undercut depth determined on the basis of a predefined insertion path (e.g., a default insertion path) of the insert body.

In step S230, the device 100 may acquire an oral modeling image that includes an undercut area divided into a plurality of areas on the basis of the scan data and the undercut area.

With regard to this, referring to FIGS. 3 to 6, the undercut areas 310, 421, 422, 441, 442, 443, 444, and 610 may be composed of values of a minimum unit (e.g., pixel, other unit area, etc.) and may include a plurality of areas distinguished based on the undercut depth.

Additionally, the undercut areas 310, 421, 422, 441, 442, 443, 444, and 610 may be determined based on operation inputs applied to the maxillary insertion path UI 320 and the mandibular insertion path UI 430, and may be determined according to the insertion paths 340 and 640 indicating the three-dimensional direction in which the insert bodies 330 and 630 can be substantially inserted into the oral cavity.

As illustrated in FIGS. 3 to 6, the undercut areas 310, 421, 422, 441, 442, 443, 444, and 610 may be determined differently depending on the insertion paths 340 and 640 of the insert bodies 330 and 630. For example, the device 100 may determine a minimum insertion path that minimizes the undercut depth (or size) among the plurality of undercut areas 310, 421, 422, 441, 442, 443, 444, and 610 acquired according to a plurality of insertion paths, and then determine and display one or more undercut areas from the plurality of undercut areas 310, 421, 422, 441, 442, 443, 444, and 610 on the basis of the minimum insertion path.

For example, the device 100 may determine the maximum value among the undercut depth values corresponding to each of the plurality of undercut areas 310, 421, 422, 441, 442, 443, 444, and 610 and determine at least one insertion path that corresponds to the undercut area with the lowest maximum value as the minimum insertion path.

Specifically, from a first undercut area having the maximum undercut depth value of 0.5 mm and a second undercut area having the maximum undercut depth value of 0.3 mm, the device 100 may determine that the insertion path corresponding to the second undercut area, which shows the lower maximum depth value, is the minimum insertion path.

The more the undercut depth is minimized, the more the ease of wearing the insert body during insertion can be improved.

In another embodiment, the minimum insertion path may refer to an insertion path where the total sum of all undercut depth values displayed on the undercut areas 310, 421, 422, 441, 442, 443, 444, and 610 is at a minimum (or falls within a predetermined level), or where the size of the undercut area with an undercut depth value exceeding a preset value is at a minimum.

The device 100 may display the undercut area corresponding to the minimum insertion path acquired based on the plurality of undercut areas 310, 421, 422, 441, 442, 443, 444, and 610.

In one embodiment, there may be an instance where the insertion path 340 or 640 is updated based on user input to the maxillary insertion path UI 320 or the mandibular insertion path UI 430. For example, the device 100 may display an updated undercut area corresponding to the insertion path updated according to the user input.

Additionally, the updated undercut area may include a plurality of areas, and these areas may be displayed in colors corresponding to the undercut depth on the updated undercut area.

For example, since the plurality of areas may include multiple pixels, they may be distinguished into different multiple areas based on the undercut depth and each area may correspond to a different color according to the undercut depth value.

The device 100 may display the updated undercut area on the basis of the color corresponding to the updated undercut depth value.

In another embodiment, the plurality of areas may be distinguished based on the range of undercut depth for the undercut areas 310, 421, 422, 441, 442, 443, 444, and 610, and the colors corresponding to the plurality of areas may be determined according to the range of undercut depth. For example, areas with the same undercut depth among the multiple areas may be distinguished by being assigned the same color.

Referring to FIGS. 3 and 6, the undercut areas 310 and 610 may be displayed as a plurality of areas distinguished by undercut depth, and these areas may be displayed in different colors according to the undercut depth.

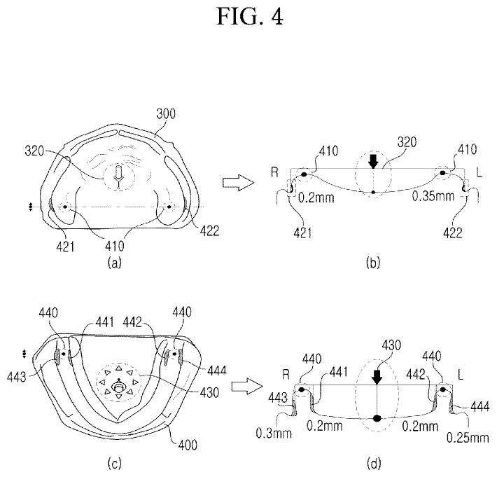

Additionally, referring to diagram (a) of FIG. 4, the plurality of areas may include maxillary tuberosity buccal undercut areas 421 and 422 based on buccal areas along a connecting line that connects maxillary tuberosity landmarks 410. Referring to diagram (c), the plurality of areas may include mandibular tuberosity buccal undercut areas 443 and 444 and mandibular tuberosity lingual undercut areas 441 and 442 based on buccal and lingual areas along a connecting line that connects mandibular tuberosity landmarks 440.

For example, the maxillary tuberosity may refer to the molar area of an edentulous maxilla, and the mandibular tuberosity may refer to the molar area of the edentulous mandible. The maxillary tuberosity buccal undercut areas 421 and 422, the mandibular tuberosity buccal undercut areas 443 and 444, and the mandibular tuberosity lingual undercut areas 441 and 442 may be among the most important areas for the denture to closely fit in the oral cavity.

The maxillary tuberosity buccal undercut areas 421 and 422 may appear as two areas on the left and right sides of the oral scan data for the maxilla, based on the connecting line connecting each maxillary tuberosity landmark 410.

The mandibular tuberosity buccal undercut areas 443 and 444 and the mandibular tuberosity lingual undercut areas 441 and 442 may appear as four areas in total: two on the left and two on the right sides of the oral scan data, based on the connecting line connecting each mandibular tuberosity landmark 440.

The connecting line may include a straight line connecting a plurality of maxillary tuberosity landmarks 410 and a straight line connecting a plurality of mandibular tuberosity landmarks 440, where the landmarks are acquired on the left and right sides of the oral scan data for the maxilla and mandible, respectively. The maxillary tuberosity buccal undercut areas 421 and 422, the mandibular tuberosity buccal undercut areas 443 and 444, and the mandibular tuberosity lingual undercut areas 441 and 442 may be displayed on the oral scan data for the maxilla and mandible corresponding to the position of the connecting line.

In a related embodiment, the connecting line can be moved in a preset direction (e.g., anterior, posterior) on the oral scan data for the maxilla and mandible according to the user input, and the movable direction may correspond to the locations of the multiple maxillary tuberosity landmarks 410, the mandibular buccal undercut areas 443 and 444, and the mandibular lingual undercut areas 441 and 442.

The maxillary tuberosity buccal undercut areas 421 and 422, mandibular buccal undercut areas 443 and 444, and mandibular lingual undercut areas 441 and 442 corresponding to the maxillary tuberosity landmarks 410 and the mandibular tuberosity landmarks 440 located at the point where the connecting line is moved according to user input may be displayed on the oral scan data or oral modeling images 300, 301, 400, and 601 for the maxilla and mandible.

In step S240, the device 100 may acquire an updated oral modeling image 500 on the basis of the undercut depth for an area adjacent to the target area 510 according to user input applied to the target area 510 that includes any one of the plurality of areas, and may display the updated oral modeling image 500. In one example, the oral modeling images 300, 301, 400, and 601 may include modeling images for the maxilla and mandible, and accordingly, the updated oral modeling image 500 may also include updated modeling images for the maxilla and mandible.

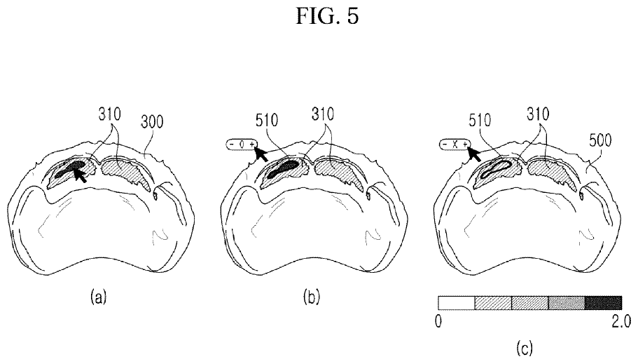

In one embodiment, the device 100 may determine the target area 510 for undercut updating on the basis of a user input applied to any one of the plurality of areas and may apply visual effects to the determined target area 510. In this regard, referring to FIG. 5, the device 100 may display the target area 510 determined based on the user input applied to any one of the plurality of areas by applying visual effects (e.g., border highlighting, color change, etc.) to indicate that the target area 510 has been selected in response to selection input.

Additionally, the device 100 may update the undercut depth of the target area 510 based on the undercut depth of the adjacent area, for example, the undercut depth of one or more of the areas adjacent to the target area 510.

For example, if the undercut depth of the target area 510 is deeper than that of the adjacent area, the contact strength of the insert body 330 or 630 may be reduced. Therefore, the device 100 may update the undercut depth of the target area 510 to correspond to the undercut depth of one or more of the areas adjacent to the target area 510. Accordingly, the undercut depth of the target area 510 may be updated to be similar to or the same as the undercut depth of the adjacent area, so that an updated oral modeling image 500 may be obtained.

FIG. 3 is a diagram illustrating an example of displaying the maxillary labial undercut area 310 determined based on the insertion path 340 of a maxillary insert body according to one embodiment.

Referring to FIG. 3, the device 100 may acquire and display the maxillary labial undercut area 310, which includes data on the undercut location and undercut depth determined on the basis of the insertion path 340 of a maxillary insert body.

The displayed maxillary labial undercut area 310 may be divided into a plurality of areas, and these areas may be updated based on the insertion path 340 of the maxillary insert body.

User input for updating the insertion path 340 of the maxillary insert body may include, for example, directional update input for the maxillary insertion path UI 320.

(a) and (b) of FIG. 3, according to one embodiment, are diagrams visually illustrating an example of the maxillary labial undercut area 310 formed when the maxillary insert body 330 is inserted from the side of the patient's maxilla along the insertion path 340 of the maxillary insert body.

For example, the device 100 may display the maxillary lateral modeling image 301 and the maxillary insert body 330 as shown in diagram (a). Subsequently, the device may display an image in which the maxillary insert body 330 is matched on a maxillary lateral modeling image 301 as shown in diagram (b), based on the insertion path 340 of the maxillary insert body determined according to user input to a preset insertion path or the maxillary insertion path UI 320 which may be displayed on one side of the maxillary lateral modeling image 301.

Specifically, referring to (b) of FIG. 3, it shows the state where the maxillary lateral modeling image 301 and the maxillary insert 330 are matched. The area marked with a circle in the maxillary lateral modeling image 301 shown in (a) includes a concave area designed to resemble the typical oral structure of a patient. As shown in (b), which depicts the maxillary insert body 330 inserted into the maxillary lateral modeling image 301 along the insertion path 340, when the maxillary insert body 330 is inserted into the maxilla, an undercut area 310 may form in the area marked with a circle due to the concave area.

In one embodiment, the device 100 may acquire matching reference points (not shown) on the basis of the maxillary lateral modeling image 301, the maxillary insert body 330, and the insertion path 340 of the maxillary insert body, and may display the matching result by matching each image based on the matching reference points, as shown in diagram (b).

(c) and (d) of FIG. 3, according to one embodiment, are diagrams visually illustrating an example of the maxillary labial undercut area 310 formed when the maxillary insert body 330 is inserted into the patient's maxilla at the time shown in the diagram along the insertion path 340 of the maxillary insert body.

For example, the device 100 may display the maxillary base modeling image 300 and the maxillary insert body 330 as shown in diagram (c).

In addition, the device 100 may display an image indicating that the maxillary labial undercut area 310 on the maxillary base modeling image 300 is updated according to the insertion path 340 of the maxillary insert body determined based on user input to the maxillary insertion path UI 320 displayed on one side of the maxillary base modeling image 300, as shown in diagram (b).

This embodiment may be equally or similarly applied in (a) and (b).

In this way, by displaying the maxillary labial undercut area 310, which is formed when the maxillary insert body 330 is inserted into the patient's oral cavity, as shown in the diagram, the user may intuitively and easily understand information about the undercut.

FIG. 4 is a diagram illustrating an example in which maxillary tuberosity buccal undercut areas, mandibular tuberosity buccal undercut areas, and mandibular tuberosity lingual undercut areas are determined and displayed according to one embodiment.

Referring to FIG. 4, the device 100 may acquire the maxillary tuberosity landmarks 410 and mandibular tuberosity landmarks 440 from the oral modeling images 300, 301, 400, and 601, as shown in (a) and (c). The device may then acquire and display the maxillary tuberosity buccal undercut areas 421 and 422, the mandibular tuberosity buccal undercut areas 443 and 444, and the mandibular tuberosity lingual undercut areas 441 and 442 on the oral modeling images 300, 301, 400, and 601, based on the buccal and lingual areas along the connecting lines connecting the maxillary tuberosity landmarks 410 and mandibular tuberosity landmarks 440, respectively.

In one embodiment, when the insertion path of the maxillary insert body or the insertion path of the mandibular insert body is updated according to user input to the maxillary insertion path UI 320 or mandibular insertion path UI 420, the maxillary tuberosity buccal undercut areas 421 and 422, mandibular tuberosity buccal undercut areas 443 and 444, and mandibular tuberosity lingual undercut areas 441 and 442 displayed based on the connecting lines of the maxilla and mandible may be updated and displayed.

When the maxillary tuberosity buccal undercut areas 421 and 422, mandibular tuberosity buccal undercut areas 443 and 444, and mandibular tuberosity lingual undercut areas 441 and 442 are updated, they are updated based on the connecting lines of the maxilla and mandible, so only the size and depth values of the undercut areas may be updated and displayed, without any change in their positions.

In one embodiment, the numerical values displayed to indicate the depth values of the maxillary tuberosity buccal undercut areas 421 and 422, mandibular tuberosity buccal undercut areas 443 and 444, and mandibular tuberosity lingual undercut areas 441 and 442 may be displayed as shown in (b) and (d).

In one embodiment, since the maxillary tuberosity buccal undercut areas 421 and 422, the mandibular tuberosity buccal undercut areas 443 and 444, and the mandibular tuberosity lingual undercut areas 441 and 442 are the most important areas when fabricating the insert bodies 330 and 630, the device 100 may display these undercut areas as the default display when displaying the maxillary base modeling image 300 and the mandibular base modeling image 400 based on the axial plane.

In one embodiment, the colors of the maxillary tuberosity buccal undercut areas 421 and 422, mandibular tuberosity buccal undercut areas 443 and 444, and mandibular tuberosity lingual undercut areas 441 and 442 may be determined in the same manner as the colors of the maxillary labial undercut area 310 and mandibular labial undercut area 610.

In one embodiment, the color of the numerical value displayed to indicate the depth value of each undercut area may be determined based on the sum of the undercut depth values for each area that constitutes the maxillary tuberosity buccal undercut areas 421 and 422, mandibular tuberosity buccal undercut areas 443 and 444, and mandibular tuberosity lingual undercut areas 441 and 442.

For example, in the case of the maxillary tuberosity buccal undercut areas 421 and 422, the color of the numerical values displayed to indicate the depth values of the right undercut area 421 and the left undercut area 422, which constitute the maxillary tuberosity buccal undercut areas, may be determined and displayed to correspond to each undercut depth value. For example, if the undercut depth value is less than a first value (e.g., 0.5 mm), it may be displayed in a first color (e.g., green); if it is greater than or equal to the first value (e.g., 0.5 mm) but less than a second value (e.g., 1 mm), it may be displayed in a second color (e.g., blue); and if it is equal to or greater than the second value (e.g., 1 mm), it may be displayed in a third color (e.g., red).

In another example, the color of the numerical values displayed to indicate the depth values of the right undercut area 421 and the left undercut area 422 may be determined based on whether the sum of the depths of the right undercut area 421 and the left undercut area 422 is greater than or equal to a third value (e.g., 1.5 mm). For example, if the sum of the depths of the right undercut area 421 and the left undercut area 422 is less than the third value, the numerical values indicating the depth values of the right undercut area 421 and the left undercut area 422 may be displayed in green, and if it is greater than or equal to the third value, the numerical values may be displayed in red.

In another example, the color of the numerical values displayed to indicate the depth value of the right undercut area 421 and the left undercut area 422, which constitute the maxillary tuberosity buccal areas 421 and 422, may be determined based on whether any one of the depths of the right undercut area 421 and the left undercut area 422 is greater than or equal to a fourth value (e.g., 2 mm) and whether the sum of the depths of the right undercut area 421 and the left undercut area 422 is greater than or equal to a fifth value (e.g., 3 mm). Alternatively, the color of the numerical values displayed to indicate the depth values of the right undercut area 421 and the left undercut area 422, which constitute the maxillary buccal undercut areas 421 and 422, may be displayed in yellow if the sum of the depths of the right undercut area 421 and the left undercut area 422 is less than the fifth value and either the right undercut area 421 or the left undercut area 422 has a depth greater than or equal to the fourth value. Alternatively, the numerical values displayed to indicate the depth values of the right undercut area 421 and the left undercut area 422, which constitute the maxillary buccal undercut areas 421 and 422, may be displayed in green if the sum of the depths of the right undercut area 421 and the left undercut area 422 is less than the fifth value and both the right undercut area 421 and the left undercut area 422 have depths less than the fourth value. In this case, even if the sum of the depths of the right undercut area 421 and the left undercut area 422 is small, the color of the numerical values displayed to indicate the depths of the right undercut area 421 and the left undercut area 422, which constitute the maxillary buccal undercut areas 421 and 422, may be displayed in yellow if either of the right undercut area 421 and the left undercut area 422 has a large depth. This allows the user to intuitively recognize the depth of the undercut area.

In this way, the color of the numerical values that indicate the depth values of the right undercut area 421 and the left undercut area 422, which constitute the maxillary tuberosity buccal undercut areas 421 and 422 may be determined differently on the basis of the undercut depth of the corresponding area and the numerical values are displayed, thereby allowing the user to easily understand the depths of the undercut areas that are the most important factors in fabricating the insert bodies 330 and 630.

FIG. 5 is a diagram illustrating an example of updating the undercut depth of a target area based on user input applied to the target area according to one embodiment.

Referring to FIG. 5, the device 100 may determine the target area 510 for undercut updating based on user input applied to the target area on the displayed maxillary base modeling image 300, and may update the undercut depth of the target area 510 to correspond to the undercut depth of the adjacent area, based on the update input applied to the determined target area 510. Specifically, as shown in (b) of FIG. 5, the target area 510 determined based on the user input may include the undercut depth corresponding to the target area 510. When user input is applied to the menu shown in (b), the depth of the target area 510 may be updated to correspond to the undercut depth of an undercut area adjacent to the target area 510.

In one embodiment, the device 100 may determine the target area 510 for undercut updating on the basis of a user input applied to any one of the plurality of areas and may apply visual effects to the determined target area 510.

Referring to FIG. 5, the device 100 may determine the target area 510 based on user input applied to any one of the plurality of areas and display the target area 510 by applying visual effects to indicate that the target area 510 has been selected.

Additionally, in one embodiment, the device 100 may provide an update interface that allows the user to update the undercut depth for the target area 510. The undercut depth update interface may include adjustment menus for size and intensity. The size may indicate the unit (e.g., 0.5 mm increments) for the range over which the undercut depth is updated according to the update input, and the intensity may indicate the unit (e.g., 0.05 mm increments) for adjusting the undercut depth of the target area 510.

The device 100 may update the undercut depth of the target area 510 based on user input regarding size and intensity provided through the undercut depth update interface.

Referring to the right-side diagram of FIG. 5, as an update input for the undercut depth is applied by the value of x, the undercut depth of the target area 510 may be updated to correspond to the undercut depth of the adjacent area.

The device 100 may determine the target area 510 based on user input applied to any one of the plurality of areas.

For example, the user input may include selection input (e.g., click input, touch input, etc.) for any one of the plurality of areas that are displayed and distinguished by color, or drag input across multiple areas. When drag input is applied to multiple areas, the determined target area 510 may be determined by a connecting line that connects the areas, regardless of the boundaries of the multiple areas.

After the target area 510 is determined, the device 100 may update the undercut area of the target area 510 based on the update input for size and intensity provided from the undercut depth update interface.

For example, if the intensity value increases according to the update input, the undercut depth of the target area 510 may decrease to correspond to the undercut depth of the adjacent area, and if the intensity value decreases according to the update input, the undercut depth of the target area 510 may increase, making the undercut area deeper.

After the undercut area of the target area 510 is updated, the device 100 may display the updated target area 510 along with visual effects indicating that the target area 510 has been selected. The visual effects may be removed based on user input regarding the removal of the visual effects or user input applied to an area outside the updated modeling image.

The embodiments described above may be applied equally or similarly to the maxillary lateral modeling image 301, the mandibular base modeling image 400, and the mandibular lateral modeling image 601.

In this way, the device 100 may update the depth of the undercut area based on user input applied to the undercut area.

In one embodiment, the device 100 may determine one undercut area to be displayed first from among a plurality of candidate undercut areas corresponding to the plurality of insertion paths 340 and 640, based on a plurality of criteria. In addition, the device may determine which undercut area will be displayed first based on a weight assigned differently to each criterion according to the significance of each criterion.

For example, the device 100 may determine which undercut area will be displayed first among the plurality of candidate undercut areas based on a weighted order of criteria, such as whether the insertion path 340 or 640 corresponding to the undercut area corresponds to a reference insertion path, the undercut depth for the undercut areas 310, 421, 422, 441, 442, 443, and 444, and the size (or area) of the undercut area.

For example, the reference insertion path may typically include the insertion paths 340 and 640 used to insert the insert bodies 330 and 630. The direction in which the insert bodies 330 and 630 are inserted usually includes a diagonal direction toward the maxilla from the front in the case of the maxilla and a vertical direction toward the occlusal plane in the case of the mandible. These directions may be the ones that make it easier for the patient to insert the insert bodies 330 and 630.

Given that the insert bodies 330 and 630 are more likely to be inserted following the reference insertion path generally used when the insert body is worn in the patient's oral cavity, the device may obtain the insertion paths that show similarity to the reference insertion path from the plurality of candidate undercut areas, and may assign the highest weight to the path with the highest similarity among the obtained similarities.

In addition, since an appropriate level of undercut depth may enhance the fit and comfort of the insert bodies 330 and 630 when worn, the undercut depth may be assigned the second-highest weight.

In addition, for the insert body 330 to maintain an appropriate level of fit when inserted, a certain amount of undercut area 310, 421, 422, 441, 442, 443, or 444 is required. However, if the undercut area 310, 421, 422, 441, 442, 443, or 444 is too large, it may make it difficult to attach and detach the insert body 330. Therefore, the size of the undercut area is important. Nonetheless, since the undercut depth has a greater impact on the fit, comfort, and ease of insertion of the insert body 330 than the size of the undercut areas 310, 421, 422, 441, 442, 443, and 444, the third-highest weight may be assigned to the size of the undercut area.

The device 100 may determine one undercut area to be displayed first from among the plurality of candidate undercut areas based on the differently assigned weights, and may display the determined undercut area.

The embodiments related to the aforementioned weights, as described with reference to FIG. 5, are presented as one example and should not be construed as being limited to the described embodiments.

FIG. 6 is a diagram illustrating an example of displaying the mandibular labial undercut area 610 determined based on the insertion path 640 of the mandibular insert body according to one embodiment.

Referring to FIG. 6, the device 100 may acquire and display the mandibular labial undercut area 610, which includes data on the undercut location and undercut depth determined based on the insertion path 640 of the mandibular insert body.

The displayed mandibular labial undercut area 610 may be divided into a plurality of areas, and these areas may be updated based on the insertion path 640 of the mandibular insert body.

User input for updating the insertion path 640 of the mandibular insert body may include, for example, directional update input for the mandibular insertion path UI 430.

(a) and (b) of FIG. 6, according to one embodiment, are diagrams visually illustrating an example of the mandibular labial undercut area 610 formed when the mandibular insert body 630 is inserted from the side of the patient's mandible along the insertion path 640 of the mandibular insert body.

For example, the device 100 may display the mandibular lateral modeling image 601 and the mandibular insert body 630 as shown in diagram (a). Subsequently, the device may display an image in which the mandibular insert body 630 is matched on the mandibular lateral modeling image 601 as shown in diagram (b), based on the insertion path 640 of the mandibular insert body determined according to user input to a preset insertion path or the mandibular insertion path UI 430 which may be displayed on one side of the maxillary lateral modeling image 601.

In one embodiment, the device 100 may acquire matching reference points (not shown) on the basis of the mandibular lateral modeling image 601, the mandibular insert body 630, and the insertion path 640 of the mandibular insert body, and may display the matching result by matching each image based on the matching reference points, as shown in diagram (b).

(c) and (d) of FIG. 6, according to one embodiment, are diagrams visually illustrating an example of the mandibular labial undercut area 610 formed when the mandibular insert body 630 is inserted into the patient's mandible at the time shown in the diagram along the insertion path 640 of the mandibular insert body.

For example, the device 100 may display the mandibular base modeling image 400 and the mandibular insert body 630 as shown in diagram (c).

In addition, the device 100 may display an image indicating that the mandibular labial undercut area 610 on the mandibular base modeling image 400 is updated according to the insertion path 640 of the mandibular insert body determined based on user input to the mandibular insertion path UI 430 displayed on one side of the mandibular base modeling image 400, as shown in diagram (b).

This embodiment may be equally or similarly applied in (a) and (b).

In this way, by displaying the mandibular labial undercut area 610, which is formed when the mandibular insert body 630 is inserted into the patient's oral cavity, as shown in the diagram, the user may intuitively and easily understand information about the undercut.

It should be appreciated that the order and combination of the steps shown above is merely an embodiment of the present disclosure, and the order, combination, branch, function and the performing subject may vary to be implemented with addition, fewer, or different steps without departing from the essential characteristics of each component described in the specification. Throughout this specification, the term “provide (or providing)” may be interpreted as comprehensively including a process in which an object obtains specific information or directly or indirectly transmits or receives specific information to or from a specific object and including the performance of related operations required in this process.

Various embodiments set forth herein may be implemented as software comprising one or more instructions stored in a storage medium (e.g., memory) that is readable by a machine (e.g., a display device or a computer). For example, a processor (e.g., the processor 120) of the machine may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

It will be understood by those of ordinary skill in the art that various changes in form and details may be made therein without departing from the characteristics described above. The disclosed methods should be considered in a descriptive sense only and not for purposes of limitation. The scope of the present disclosure is defined by the appended claims rather than by the foregoing description, and all differences within the scope of equivalents thereof should be construed as being included in the present disclosure.

1. A method for displaying an oral modeling image used for manufacturing an insert body, the method comprising the steps of:
acquiring scan data for an oral cavity;
acquiring undercut data including data on undercut location and undercut depth determined on the basis of an insertion path of an insert body corresponding to the oral cavity;
acquiring an oral modeling image including an undercut area divided into a plurality of areas on the basis of the scan data and the undercut data;
acquiring an updated oral modeling image on the basis of the undercut depth for an area adjacent to a target area according to a user input applied to the target area including one of the plurality of areas; and
displaying the updated oral modeling image.

2. The method of claim 1, wherein the plurality of areas are distinguished based on the undercut depth and each area corresponds to a different color.

3. The method of claim 1, wherein the acquiring of the updated oral modeling image comprises updating the undercut depth of the target area according to the undercut depth of the adjacent area.

4. The method of claim 1, wherein the undercut area is determined on the basis of an insertion path that minimizes a depth of the undercut area among a plurality of insertion paths.

5. The method of claim 1, wherein the plurality of areas comprise a maxillary tuberosity buccal undercut area based on a buccal area along a connecting line that connects maxillary tuberosity landmarks.

6. The method of claim 5, wherein a color of a numerical value displayed to indicate a depth value of the maxillary tuberosity buccal undercut area included in the undercut area is determined on the basis of the sum of undercut depth values of two areas that constitute the maxillary tuberosity buccal undercut area.

7. The method of claim 1, wherein the acquiring of the updated oral modeling image comprises the steps of:
determining the target area for undercut updating on the basis of a user input applied to the undercut area; and
updating an undercut depth of the target area to correspond to the undercut depth of the adjacent area.

8. The method of claim 1, wherein the acquiring of the undercut data comprises determining the undercut data such that the undercut depth is minimized on the basis of a plurality of insertion paths.

9. The method of claim 1, wherein the plurality of areas comprise a plurality of pixels included in the undercut area, and colors corresponding to the plurality of areas are determined according to the undercut depths of the plurality of areas.

10. The method of claim 1, wherein the plurality of areas are distinguished based on a range of undercut depth for the undercut area, and colors corresponding to the plurality of areas are determined according to a range of the undercut depth.

11. A device for displaying an oral modeling image used for manufacturing an insert body, the device comprising:
a receiving unit configured to acquire scan data for an oral cavity and acquire undercut data including data on undercut location and undercut depth determined on the basis of an insertion path of an insert body corresponding to the oral cavity;
a processor configured to acquire an oral modeling image including an undercut area divided into a plurality of areas on the basis of the scan data and the undercut data and acquire an updated oral modeling image on the basis of the undercut depth for an area adjacent to a target area according to a user input applied to the target area including one of the plurality of areas; and
a display configured to display the updated oral modeling image.

12. The device of claim 11, wherein the plurality of areas are distinguished based on the undercut depth and each area corresponds to a different color.

13. The device of claim 11, wherein the plurality of areas comprise a maxillary tuberosity buccal undercut area based on a buccal area along a connecting line that connects maxillary tuberosity landmarks.

14. The device of claim 11, wherein the processor is configured to determine the target area for undercut updating on the basis of a user input applied to the undercut area and update the undercut depth of the target area to correspond to the undercut depth of the adjacent area.

15. A computer-readable recording medium having stored thereon a program which, when executed by a computer system, causes the computer system to perform a method for displaying an oral modeling image used for manufacturing an insert body, wherein the method comprises the steps of:
acquiring scan data for an oral cavity;
acquiring undercut data including data on undercut location and undercut depth determined on the basis of an insertion path of an insert body corresponding to the oral cavity;
acquiring an oral modeling image including an undercut area divided into a plurality of areas on the basis of the scan data and the undercut data;
acquiring an updated oral modeling image on the basis of the undercut depth for an area adjacent to a target area according to a user input applied to the target area including one of the plurality of areas; and
displaying the updated oral modeling image.

16. The computer-readable recording medium of claim 15, wherein the acquiring of the updated oral modeling image comprises updating the undercut depth of the target area according to the undercut depth of the adjacent area.

17. The computer-readable recording medium of claim 15, wherein the acquiring of the updated oral modeling image comprises the steps of:
determining the target area for undercut updating on the basis of a user input applied to the undercut area; and
updating an undercut depth of the target area to correspond to the undercut depth of the adjacent area.

18. The computer-readable recording medium of claim 15, wherein the acquiring of the undercut data comprises determining the undercut data such that the undercut depth is minimized on the basis of a plurality of insertion paths.

19. The computer-readable recording medium of claim 15, wherein the plurality of areas comprise a plurality of pixels included in the undercut area, and colors corresponding to the plurality of areas are determined according to the undercut depths of the plurality of areas.

20. The computer-readable recording medium of claim 15, wherein the plurality of areas are distinguished based on a range of undercut depth for the undercut area, and colors corresponding to the plurality of areas are determined according to a range of the undercut depth.
